(19) United States
(12) Patent Application Publication
(10) Pub. No.: US 2026/0126973 A1
(43) Pub. Date: May 7, 2026

(54) EXPRESSIVITY-AWARE TRANSPILER ARCHITECTURE FOR WORKFLOW LANGUAGES

(71) Applicant: Hewlett Packard Enterprise Development LP, Spring, TX (US)

(72) Inventors: Alok Mishra, Edison, NJ (US); Rolando Pablo Hong Enriquez, Bicester (GB); Dejan S. Milojicic, Palo Alto, CA (US); Barbara M. Chapman, Miller Place, NY (US)

(21) Appl. No.: 18/940,407

(22) Filed: Nov. 7, 2024

(51) Int. Cl. G06F 8/41; G06F 40/263

(52) U.S. Cl. CPC G06F 8/41; G06F 40/263

(57) ABSTRACT

A system determines a set of workflow languages which capture tasks to be executed in a corresponding workflow. The system defines a set of classes of expressivity, wherein a class of expressivity represents a workflow language. The system identifies, in the set of workflow languages, an input language and a target output language. The system determines whether the target output language is a match for the input language by comparing a respective class of expressivity for the input language and the respective class of expressivity for the target output language. The system returns information associated with whether the target output language is a match for the input language.

### BACKGROUND

Workflows may be created in various fields, such as particle physics and bio-informatics, to manage coordination of large complex tasks. Different workflow management systems (WFMs) and workflow languages (WFLs) may be used to execute these workflows. As a result, communication and interoperability between such WFMs may be difficult. One approach may be to create a single universal language to cover all workflows in all fields. However, such a solution may generally not be feasible. Another approach may be to create a universal translator. However, current solutions are mostly tailored to specific software backend tasks or are generated opportunistically, e.g., on a one-to-one basis to solve a specific problem.

### BRIEF DESCRIPTION OF THE FIGURES

FIG. 1 illustrates an environment facilitating an expressivity-aware transpiler for workflow languages, in accordance with an aspect of the present application.

FIG. 2A illustrates a diagram depicting an operational definition of expressivity, in accordance with an aspect of the present application.

FIG. 2B illustrates a diagram illustrating sample classes of expressivity, in accordance with an aspect of the present application.

FIG. 2C depicts a diagram calculating the expressivity score for a syntactic class for two languages, in accordance with an aspect of the present application.

FIG. 3 illustrates a diagram including a flow of operations for adding a new class of expressivity, in accordance with an aspect of the present application.

FIG. 4 illustrates a diagram depicting support for compensating for potential functionality losses, in accordance with an aspect of the present application.

FIG. 5 illustrates interactions between workflow managers and a workflow transpiler, in accordance with an aspect of the present application.

FIG. 6A presents a flowchart illustrating a method which facilitates an expressivity-aware transpiler for workflow languages, in accordance with an aspect of the present application.

FIG. 6B presents a flowchart illustrating a method which facilitates an expressivity-aware transpiler for workflow languages, including the determination of whether a target output language is a match for an input language, in accordance with an aspect of the present application.

FIG. 6C presents a flowchart illustrating a method for analyzing a gap between an input language and a target output language, in accordance with an aspect of the present application.

FIG. 7 illustrates a computer system which facilitates an expressivity-aware transpiler for workflow languages, in accordance with an aspect of the present application.

FIG. 8 illustrates a computer-readable medium which facilitates an expressivity-aware transpiler for workflow languages, in accordance with an aspect of the present application.

In the figures, reference numerals refer to the same figure elements.

### DETAILED DESCRIPTION

Aspects of the present application provide a framework which translates from an input workflow language to a target workflow language based on multiple classes of “expressivity,” which can be the capacity of a language to be represented by or based on, e.g., syntax, semantics, conceptual elements, absolute linguistics, runtime measurements, and graphs. The framework may also be referred to as an “expressivity-aware transpiler.”

A “workflow” (WF) may be a structured sequence of tasks, processes, or applications that coordinate the execution of computations, data transfers, and dependencies, often across distributed systems, in order to efficiently achieve a specified goal in, e.g., High-Performance Computing (HPC) environments. An “application” may be a software program designed to perform specific computational tasks or solve defined problems, e.g., by utilizing available hardware resources, often in parallel in the context of HPC. A “workflow language” (WFL) may be a specialized language that designs, manages, and automates the execution of workflows by specifying task sequences, data dependencies, and control logic, which may result in effective task orchestration in distributed or parallel computing environments.

Workflows may be created in various fields, such as particle physics and bio-informatics, to manage coordination of large complex tasks. Different workflow management systems (WFMs) and workflow languages (WFLs) may be used to execute these workflows. As a result, communication and interoperability between such WFMs may be difficult. One approach may be to create a single universal language to cover all workflows in all fields. However, such a solution may generally not be feasible. Another approach may be to create a universal translator. However, current solutions are mostly tailored to specific software backend tasks or are generated opportunistically, e.g., on a one-to-one basis to solve a specific problem.

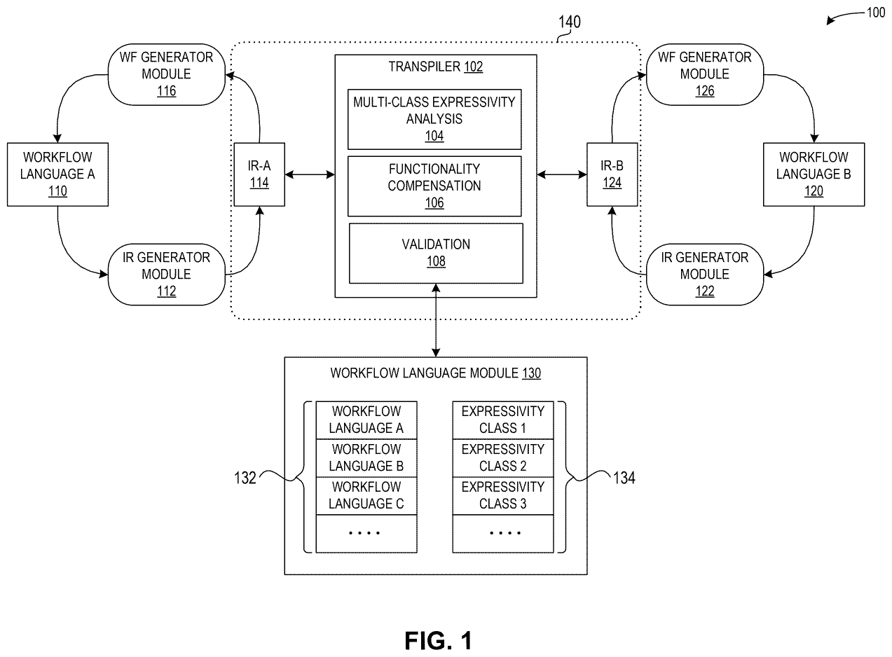

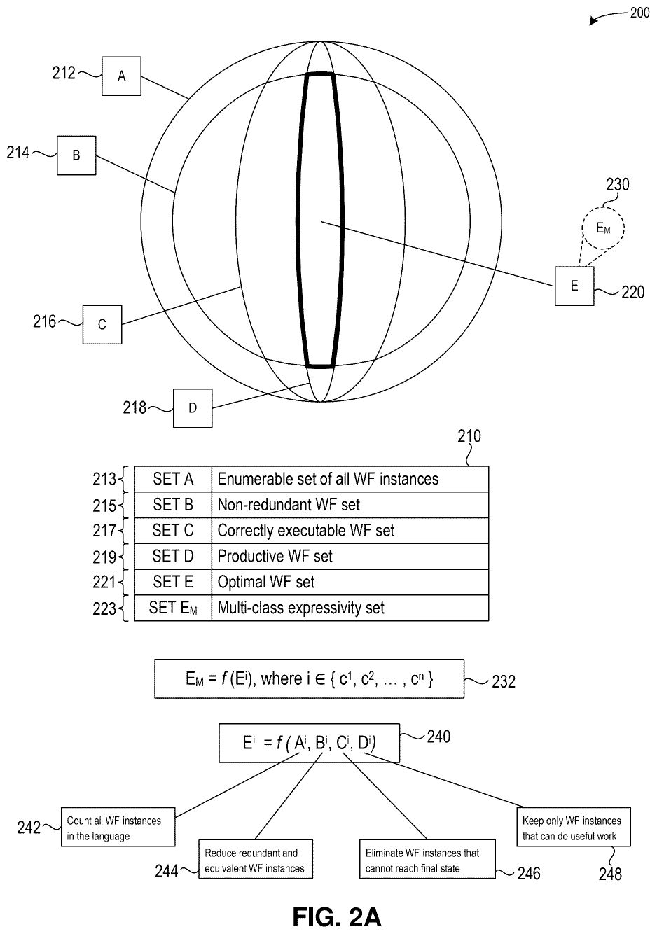

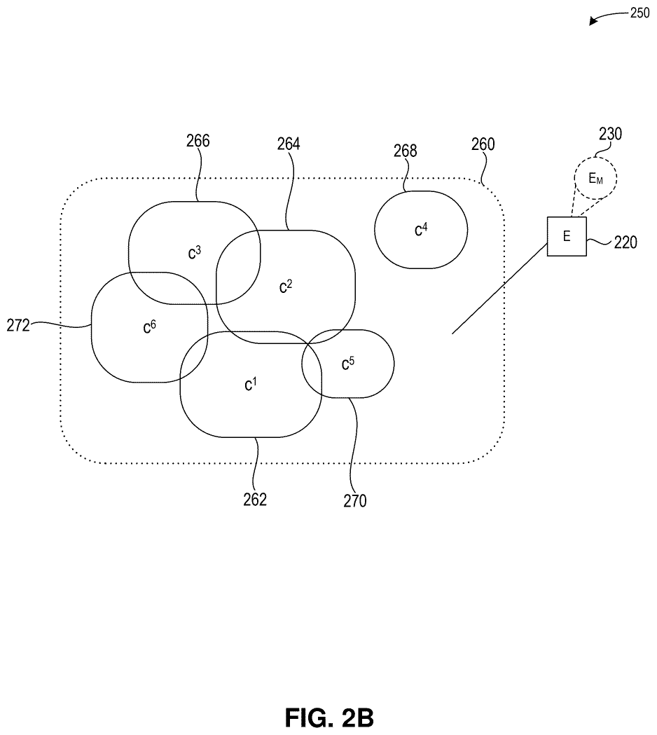

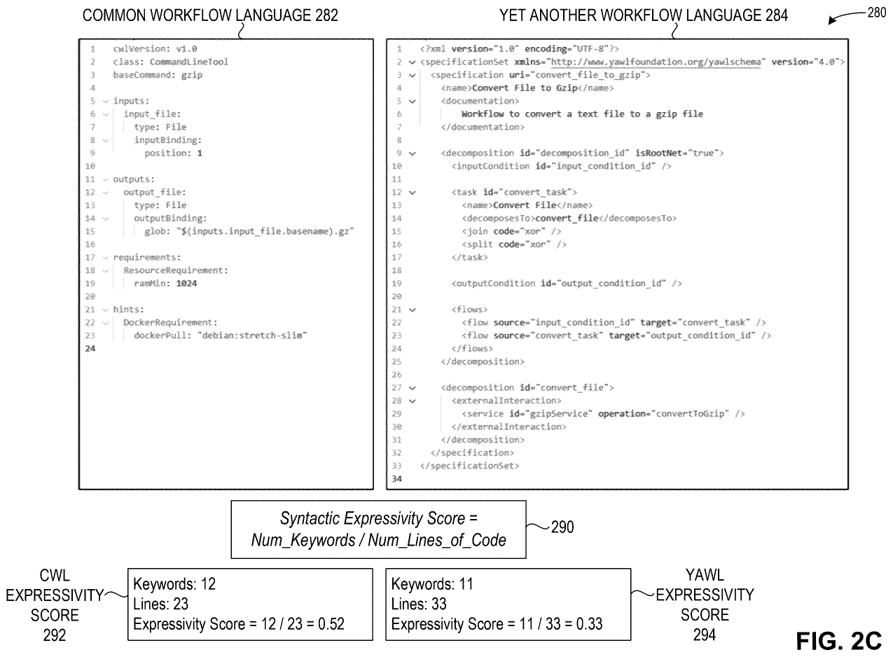

The described aspects address the limitations of the current approaches by providing a framework which translates from an input WFL to a target WFL based on multiple classes of expressivity. The framework may include a “transpiler” (i.e., a system which translates one language to another language at a similar level of abstraction using compiler technology). The transpiler may include information on multiple workflow languages and multiple expressivity classes, as described below in relation to FIG. 1. The expressivity classes may be based on, e.g., syntax, semantics, conceptual elements, absolute linguistics, graphs, etc., as described below in relation to FIG. 2B.

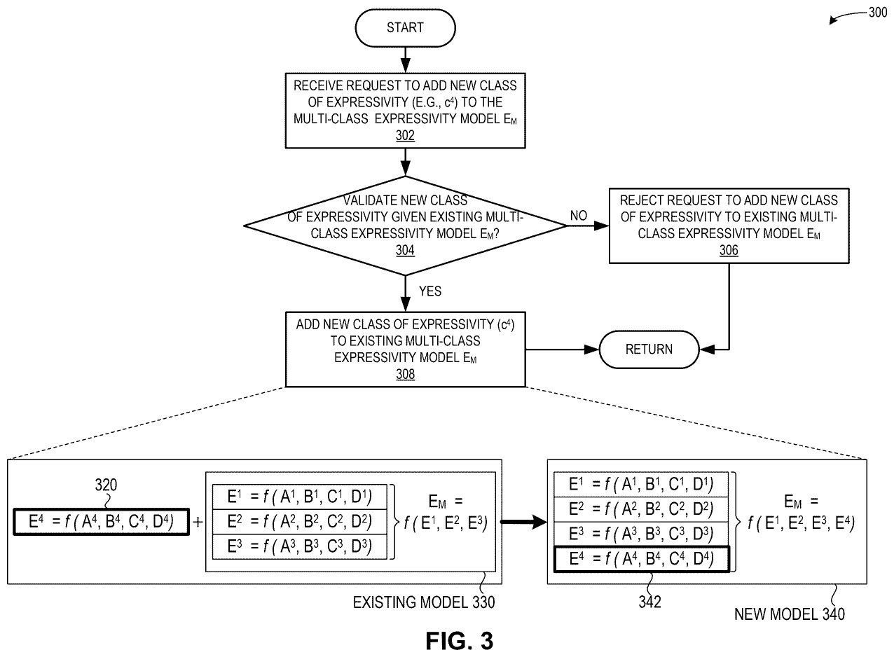

In the described aspects, given an input workflow language (or “input language”) and a target output workflow language (or “target output language”), the transpiler can determine whether the target output language is a match for the input language by performing a multi-class expressivity analysis, e.g., by comparing each class of expressivity for the input language against the same class of expressivity for the target output language and calculating expressivity scores for each class. The transpiler can estimate the “multi-class expressivity” by aggregating these expressivity scores. The transpiler can return information associated with whether the target output language is a match for the input language. The returned information may also include a recommendation of alternate target output languages which may be a better match for the input language (based on the multi-class expressivity analysis). The transpiler may also add new WFLs or new expressivity classes by performing validation on the new WFLs and new expressivity classes. Adding and validating new WFLs and expressivity classes is described below in relation to FIG. 3.

Thus, the described aspects provide a transpiler framework based on classes of expressivity. New WFLs and classes of expressivity may be added to the transpiler, which may result in a universal transpiler that operates with increased modularity and scalability.

FIG. 1 illustrates an environment 100 facilitating an expressivity-aware transpiler for workflow languages, in accordance with an aspect of the present application. Environment 100 depicts the translation of a workflow language A (110) into a workflow language B (120), by way of respective intermediate representations (respectively, IR-A 114 and IR-B 124) which are input to and output from a transpiler 102. A workflow language may be transformed into an intermediate representation by an IR generator module, and an intermediate representation may be transformed back into a workflow language by a workflow generator module. For example: workflow language A (110) may be input into an IR generator module 112, which may output the intermediate representation of workflow language A as IR-A 114; and IR-A 114 may be input into a WF generator module 116, which may output workflow language A. Similarly: workflow language B (120) may be input into an IR generator module 122, which may output the intermediate representation of workflow language B as IR-B 124; and the IR-B 124 may be input into a WF generator module 126, which may output the workflow language B.

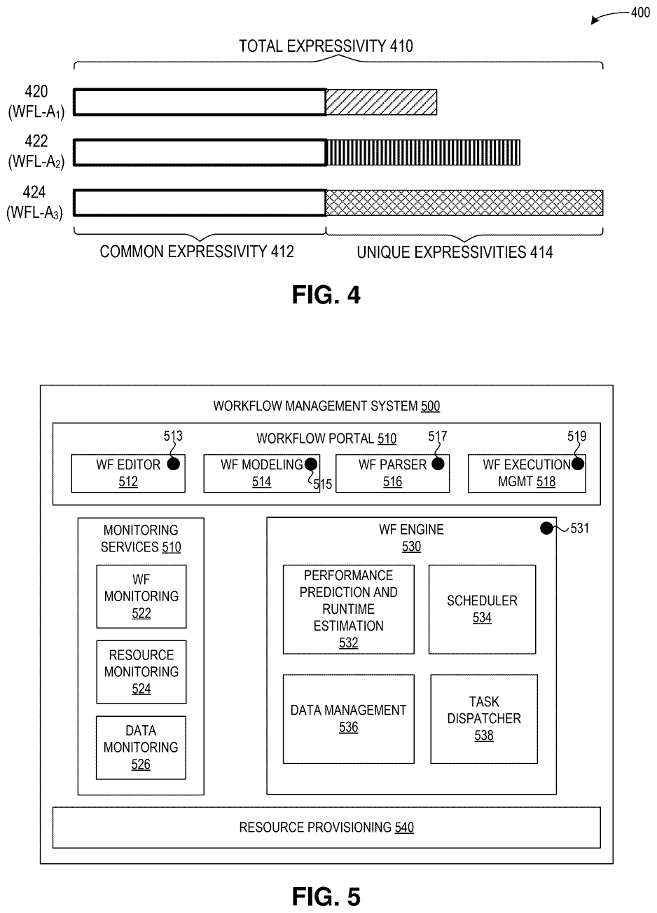

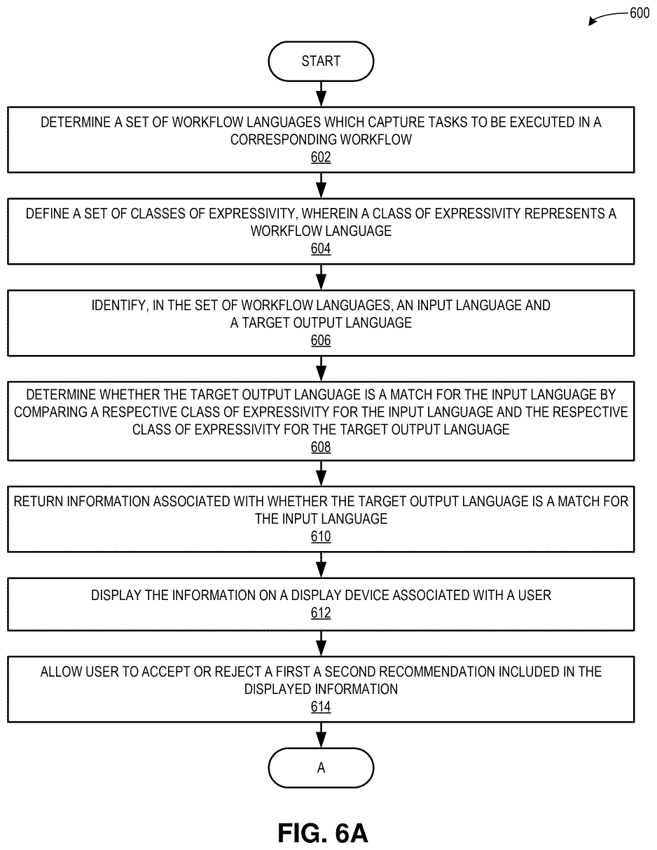

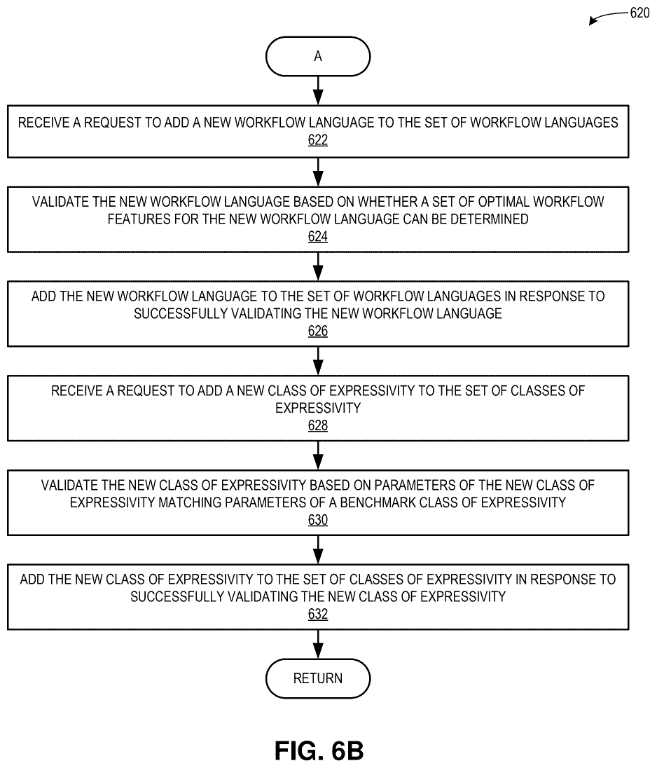

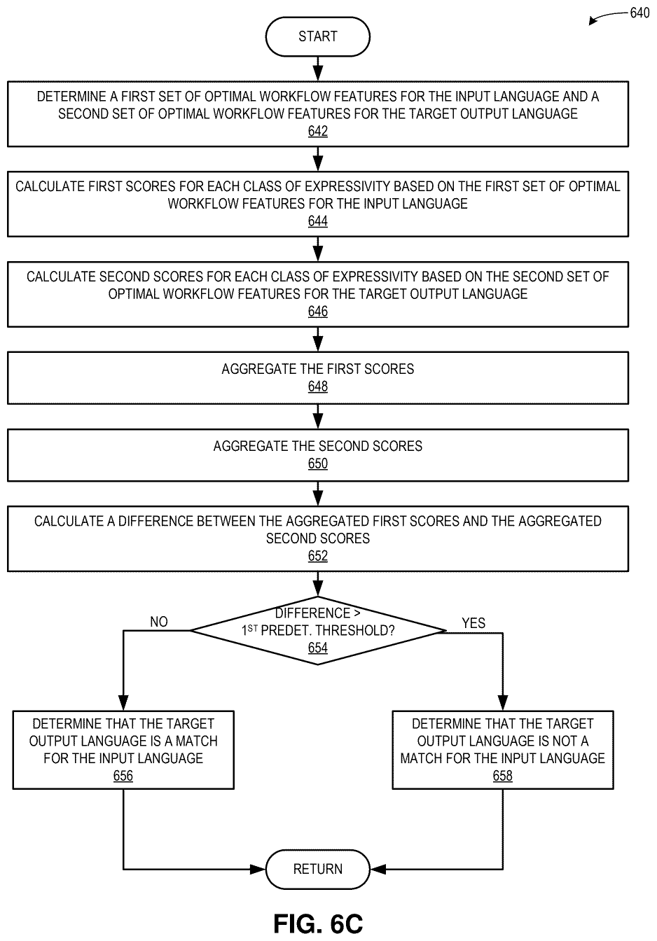

A dashed-line box 140 may indicate encapsulated functionalities, depicted in environment 100 as modules, which may also be implemented in hardware, software, or a combination of hardware and software. Transpiler 102 may include: a multi-class expressivity analysis module 104, as described below in relation to FIGS. 2A, 2B, 6A, and 6C; a functionality compensation module 106, as described below in relation to FIG. 4; and a validation module 108, as described below in relation to FIGS. 3 and 6B. Transpiler 102 may communicate with a workflow language module 130 (which may be separate from encapsulated functionalities 140). Workflow language module 130 may include: a set of workflow languages 132, e.g., workflow language A, workflow language B, workflow language C, etc.; and a set of classes of expressivity 134, e.g., expressivity class 1, expressivity class 2, expressivity class 3, etc.

FIG. 2A illustrates a diagram 200 depicting an operational definition of expressivity, in accordance with an aspect of the present application. Diagram 200 indicates workflow instances in a visual depiction and in a table 210. The visual depiction can include: a set A (212, described in an entry 213 of table 210) as the enumerable set of all workflow instances, shown as the largest circle; a set B (214, described in an entry 215 of table 210) as the set of non-redundant workflow instances, shown as the second largest circle; a set C (216, described in an entry 217 of table 210) as the set of correctly executable workflow instances, shown as the largest oval; a set D (218, described in an entry 219 of table 210) as the set of productive workflow instances, shown as the smaller oval. In the visual depiction, the only intersecting portion of these sets is a set E (220, described in an entry 221 of table 210) of the optimal workflow instances, shown as a space with a bold outline. This set E (220) may be referred to as the set E_{M} (230, described in an entry 231 of table 210) or the multi-class expressivity set. As shown in element 232, the multi-class expressivity set E_{M} can be a function of the expressivity of each class c¹, c², c³, etc. As shown in element 240, the expressivity of each individual class may be a function of determining each of the above-described sets A, B, C, and D. Specifically: Aⁱ is the set resulting from counting all the workflow instances in the language (242); Bⁱ is the set resulting from reducing redundant and equivalent workflow instances (244); Cⁱ is the set resulting from eliminating workflow instances which cannot reach the final state (246); and Dⁱ is the set resulting from keeping only the workflow instances which do useful work (248). As shown in element 240 and based on a function (e.g., an intersection) of sets A-D (212-218), the resulting set of workflow instances for a given class of expressivity (Ei) may be an optimal set from which the system can extract the expressivity of the workflow language.

FIG. 2B illustrates a diagram 250 illustrating sample classes of expressivity, in accordance with an aspect of the present application. Diagram 250 indicates six classes of expressivity, including classes c¹-c⁶. A class c¹ may correspond to syntactic expressivity (262), which may include an arrangement of symbols based on rules and relationship between the symbols. The symbols may belong to various categories and may be used as elements in or associated with rules. The elements may be combined into grammars with a certain complexity and expressive power. A class c² for semantic expressivity (264) may include a compilation-based type of assessment and may be used to quantify changes in expressivity. This may be generally based on the concept that by adding a feature (F) to a workflow language (L) where the newly created language (L′=L+F) “compiles to” the workflow language L, then the feature F does not add any expressive power over the workflow language L.

A class c³ for conceptual expressivity (266) may cover, within the context of computational workflows, a language-independent canonical set of conceptual features. Workflows may be tokenized into their conceptual elements, dependencies, and relationships to create conceptual maps, and conceptual maps from different workflow languages may be used as a base to create measures of conceptual expressivity. A class c⁴ for absolute linguistic expressivity (268) may indicate a distance-based measure which is to be computed between every independent workflow language and a reference Infinitely Expressive Language (IEL).

A class c⁵ for dynamic or runtime expressivity (270) may include executing workflows originating from a selected workflow language in a variety of ways at runtime. Using a different workflow language may potentially increase or decrease the number of execution paths of a given workflow, and the system may use this variability to derive measures of dynamical workflow expressivity. A class c⁶ for graph-based mathematical expressivity (272) may include mapping workflows expressed in their own workflow languages into arbitrarily complex mathematical graphs. The system can implement several measures of mathematical expressivity on these graphs and subsequently use those measures to determine and precisely quantify expressivity differences between workflow languages.

In some aspects, each class Eⁱ=f(Aⁱ, Bⁱ, Cⁱ, Dⁱ) may be implemented according to benchmark or prototypical E_{M} parameters, yet still allow a programmer the freedom to implement the internal details of specific expressivity classes.

FIG. 2C depicts a diagram 280 calculating the expressivity score for a syntactic class (e.g., class c¹ described above as element 262 in diagram 250 of FIG. 2B) for two languages, in accordance with an aspect of the present application. Diagram 280 includes sample code excerpts from two different workflow languages: a Common Workflow Language (CWL) code excerpt 282; and a Yet Another Workflow Language (YAWL) code excerpt 284. An element 290 indicates one manner in which the syntactic expressivity score may be calculated, e.g., as the number of keywords (“Num_Keywords”) divided by the number of lines of code (“Num_Lines_of_Code”).

Diagram 280 further illustrates a corresponding calculation of the syntactic expressivity score for each of the depicted workflow language flows. Given 12 keywords and 23 lines of code, the CWL expressivity score 292 can be: 12/23=0.52. Given 11 keywords and 33 lines of code, the YAWL expressivity score 294 can be: 11/33=0.33. On one hand, these expressivity scores demonstrate that CWL may offer a higher syntactic expressivity, resulting in more compact and comprehensible code which may be simpler to learn, maintain, and administer, especially for smaller operations. On the other hand, these expressivity scores show that YAWL may offer reduced syntactic expressivity while providing more detailed and explicit workflow control.

FIG. 3 illustrates a diagram 300 including a flow of operations for adding a new class of expressivity, in accordance with an aspect of the present application. The system (e.g., transpiler 102 of FIG. 1) may receive a request to add a new class of expressivity (e.g., c⁴) to the multi-class expressivity model E_{M} (e.g., as described above in relation to elements 230 and 232 of FIG. 2A) (operation 302). The system can perform validation of this new class, e.g., validating the new class of expressivity given the existing multi-class expressivity model E_{M}. The system may perform this validation based on whether parameters of the new expressivity class for (A⁴, B⁴, C⁴, D⁴) match parameters of a benchmark class for (A, B, C, D). If the system does not validate the new class of expressivity given the existing multi-class expressivity model E_{M} (decision 304), the system rejects the request to add the new class of expressivity to the multi-class expressivity model (operation 306). The operation returns, or, in some aspects, the parameters or definitions of the new class of expressivity may be modified and the operation may return to operation 302 (not shown) until the new class is validated.

If the system does validate the new class of expressivity given the existing multi-class expressivity model E_{M} (decision 306), the system adds the new class of expressivity (c⁴) to the existing multi-class expressivity model E_{M} (operation 308), and the operation returns. For example, an existing model 330 may include a set of three classes of expressivity and may be represented as E_{M}=f(E¹, E², E³), where each class of expressivity Eⁱ is as listed above in relation to element 240 of FIG. 2A, i.e.: E¹=f(A¹, B¹, C¹, D¹); E²=f(A², B², C², D²); and E³=f(A³, B³, C³, D³). An element 320 indicates that a new class of expressivity E⁴ has been validated (as indicated by the bold outlined box) and is to be added to existing model 330, resulting in a new multi-class expressivity model 340. New model 340 may be represented as E_{M}=f(E¹, E², E³, E⁴), where element 342 indicates the newly added and validated class E⁴=f(A⁴, B⁴, C⁴, D⁴).

When transpiling an input language to a target output language, the described aspects of the transpiler (e.g., transpiler 102) may consider the differences in the expressivity of the source and target workflow languages and may compensate for any missing functionalities encountered throughout the conversion process. FIG. 4 illustrates a diagram 400 depicting support for compensating for potential functionality losses, in accordance with an aspect of the present application. The operations described herein relating to diagram 400 may be performed by, e.g., functionality compensation module 106 of FIG. 1 and may indicate how to determine or analyze the gap between two workflow languages (e.g., an input workflow language and one of a plurality of target output languages).

Diagram 400 illustrates three workflow languages: a workflow language 420, also referred to as “WFL-A₁”; a workflow language 422, also referred to as “WFL-A₂”; and a workflow language 424, also referred to as “WFL-A₃.” The rectangular bars can indicate the expressivity of each workflow language, including: a total expressivity 410; a common expressivity 412 indicating with a bold outline for all three workflow languages; and unique expressivities 414 indicated by different shading for each of the three workflow languages. For example: the unique expressivities of WFL-A₁ are indicated by right-slanting lines in the shading; the unique expressivities of WFL-A₂ are indicated by vertical lines in the shading; and the unique expressivities of WFL-A₃ are indicated by a diagonal cross-hatch pattern in the shading. Thus, diagram 400 depicts that the three languages have a certain amount of common expressivity and a certain varying amount of unique expressivities between the languages.

The system may perform an analysis of transpiling WFL-A₁ to WFL-A₂ by determining the common and unique expressivities between these two workflow languages, e.g., by transpiling the common expressivity sections between WFL-A₁ and WFL-A₂. The system may achieve this by using a common versus a unique expressivity classifier. The system may also flag unique expressivities and their locations in the WFL-A₂, e.g., by determining the expressivity “distance.”

The system may try to use the unique expressivities in WFL-A₁ to write functionally equivalent code in WFL-A₂. Because WFL-A₁ is less expressive and dissimilar than WFL-A₂, the system may not be successful in writing the functionally equivalent code in WFL-A₂. Alternatively, the system may find another workflow language (e.g., WFL-A₃) that is a better match to write functionalities from WFL-A₂ to WFL-A₁, e.g., an expressivity “recommender.”

The system may determine to write the final transpiled workflow in either: the new recommended language (WFL-A₃, which may be considered as “partitioning” the input language to obtain the target output language); or a combination of the source WFL target (WFL-A₁) and the new recommended language (WFL-A₃, which may be expressed as an aggregation, i.e., WFL-A₁+WFL-A₃).

Thus, the described aspects can provide support for multi-language workflows and compensate for potential functionality losses using the above-described steps or operations.

The described embodiments may be used and integrated into a concrete, tangible, and practical application by interacting with a workflow manager or a workflow management system. FIG. 5 illustrates interactions between a workflow management system 500 (e.g., a workflow manager) and a workflow transpiler, in accordance with an aspect of the present application. The components, units, modules, or entities illustrated in FIG. 5 are depicted for illustrative purposes only. Workflow management system 500 may include more or fewer components, units, modules, or entities than those illustrated in FIG. 5. Workflow management system 500 may include a workflow portal 510, monitoring services 520, and a workflow engine 530. Workflow portal 510 may include a workflow editor 512, a workflow modeling unit 514, a workflow parser 516, and a workflow execution management module 518. Monitoring services 520 may include: a workflow monitoring unit 522; a resource monitoring unit 524; and a data monitoring unit 526. Workflow engine 530 may include: a performance prediction and runtime estimation model 532; a scheduler 534; a data management unit 536; and a task dispatcher 538.

The shaded-in circles 513, 515, 517, and 519 may indicate the workflow (WF) transpiler as described herein. The WF transpiler may interact or communicate with each marked unit or module of WFM 500 in a specific manner. For example, circle 513 in WF editor 512 indicates that during editing and in real-time, a workflow may be automatically transpiled into several WFLs and allow the user the select the final choice. As another example, circle 515 in WF modeling unit 514 indicates that workflow simulation and modeling components may play or execute off-line scenarios and thus optimize the workflows by considering features offered by different workflow languages.

Circle 517 in WF parser 516 indicates that the WF transpiler may interact with third-party transpilers in other WFMs, in addition to a WF parser used within the described environment of transpiler 102 of FIG. 1. Circle 519 in WF execution management unit 518 indicates that a user may decide to transpile part of a running workflow into another workflow language and allow it to run in either the current WFM or an external WFM.

As another example, circle 531 in workflow engine 530 indicates that the transpiler may interact in several ways with workflow engines, e.g., by receiving feedback from performance prediction tools (e.g., 532) on sub-workflows, which can then be transpiled into more suitable workflow languages and sent for execution to a scheduler (e.g., 534).

FIG. 6A presents a flowchart illustrating a method 600 which facilitates an expressivity-aware transpiler for workflow languages, in accordance with an aspect of the present application. During operation, the system determines a set of workflow languages which capture tasks to be executed in a corresponding workflow (operation 602). For example, transpiler 102 of FIG. 1 may perform operations as the system described herein, and workflow language module 130 may include a set of workflow languages 132, e.g., workflow language A, workflow language B, workflow language C, etc. The set of workflow languages may be added to a repository (e.g., workflow language module 130 of FIG. 1), and the system may determine the set of workflow languages by accessing the repository storing the set of workflow languages (e.g. transpiler 102 may retrieve workflow language information from module 130 of FIG. 1).

The system defines a set of classes of expressivity, wherein a class of expressivity represents a workflow language (operation 604). Workflow language module 130 in FIG. 1 may also include a set of expressivity classes 134, e.g., an expressivity class 1, an expressivity class 2, an expressivity class 3, etc. Similarly, existing model 330 in FIG. 3 may include three expressivity classes: E1, E2, and E3, which may be expressed in aggregate as E_{M}=f(E¹, E², E³), as described above in relation to element 240 of FIG. 2A depicting the optimal workflow set for a given expressivity class Eⁱ.

The system identifies, in the set of workflow languages, an input language and a target output language (operation 606). For example, in environment 100 of FIG. 1, transpiler 102 may identify a workflow language A (110), via its intermediate representation IR-A (114) as the input language, and transpiler 102 may further identify a workflow language B (120) via its intermediate representation IR-B (124) as the target output language.

The system determines whether the target output language is a match for the input language by comparing a respective class of expressivity for the input language and the respective class of expressivity for the target output language (operation 608). The system (e.g., transpiler 102 of FIG. 1) may determine whether the target output language (or another target output language) is a match for the input language based on analyzing a gap between the input language and one or more target output languages. For example, FIG. 4 describes an analysis of transpiling WFL-A₁ to WFL-A₂ by determining common and unique expressivities between the two WFLs and FIG. 6C depicts operations performed while analyzing a gap between the two WFLs. An example of calculating scores for each expressivity class based on certain optimal workflow features for the input language and the target output languages is provided above in relation to calculating the syntactic expressivity score for the two workflow languages (CWL and YAWL) depicted in FIG. 2C.

The system returns information associated with whether the target output language is a match for the input language (operation 610), and the system displays the information on a display device associated with a user (operation 612). The user may have identified the input language (e.g., by selecting the input language from the information displayed to the user, such as workflow language A (110) in FIG. 1) while waiting for transpiler 102 to determine which target output language to identify and return to the user (such as workflow language B (120) in FIG. 1).

The system allows the user to accept or reject a first or a second recommendation included in the displayed information (operation 614). The returned and displayed information may include interactive elements allowing the user to accept or reject a first recommendation included in the displayed information, wherein the first recommendation indicates that the target output language is a match for the input language. The interactive elements may also allow the user to accept or reject a second recommendation included in the displayed information, wherein the second recommendation indicates that the target output language is not a match for the input language and further recommends a first alternative target output language or a second alternative target output language, as described above in relation to the functionality compensation module 106 of FIG. 1. An example of an alternative target output language is provided above in relation to the total, common, and unique expressivities of FIG. 4. The operation continues at Label A of FIG. 6B.

FIG. 6B presents a flowchart 620 illustrating a method which facilitates an expressivity-aware transpiler for workflow languages, including the determination of whether a target output language is a match for an input language, in accordance with an aspect of the present application. The system receives a request to add a new workflow language to the set of workflow languages (operation 622). This type of request may represent an exception to the normal operation of the transpiler and may originate from system developers instead of workflow developers. The normal operation of the transpiler can be making translations between validated workflow languages. The system validates the new workflow language based on whether a set of optimal workflow features for the new workflow language can be determined (operation 624). For example, as depicted above in relation to FIG. 3, the system may validate a new workflow language by determining whether the optimal set of workflow features Eⁱ (based on a function of Aⁱ, Bⁱ, Cⁱ, and Dⁱ) for the new workflow language can be determined, where: set A (212) corresponds to the enumerable set of all workflow instances; set B (214) corresponds to a set of non-redundant workflows; set C (216) corresponds to a set of correctly executable workflows; and set D (218) corresponds to a productive set of workflows.

The system adds the new workflow language to the set of workflow languages in response to successfully validating the new workflow language (operation 626). If the system does not successfully validate the new workflow language, the system may reject the new workflow language (not shown). On exit, the system may provide information about the reason for rejecting the workflow language in the form of a validation error.

The system also receives a request to add a new class of expressivity to the set of classes of expressivity (operation 628), as described above in relation to operation 302 of FIG. 3. The system validates the new class of expressivity based on parameters of the new class of expressivity matching parameters of a benchmark class of expressivity (operation 630). For example, as depicted above in relation to FIG. 3, the system may validate a new expressivity class E⁴ (320) by determining whether the parameters of set E⁴ (based on a function of A⁴, B⁴, C⁴, and D⁴) match parameters of a benchmark expressivity class (not shown).

The system adds the new class of expressivity to the set of classes of expressivity in response to successfully validating the new class of expressivity (operation 632), as described above in relation to decision 304 and operation 308 of FIG. 3. For example, the system may add the new expressivity class E⁴ (320) to existing model 330, which results in new model 340 which includes E⁴ as one of the expressivity classes in the multi-class expressivity model 340. If the system does not successfully validate the new class of expressivity, the system may reject the new class of expressivity (as depicted in relation to operation 306 of FIG. 3; not shown in FIG. 6B). The system may send the rejected new class of expressivity to an external or other entity for modification and may subsequently receive the modified new expressivity class as part of another request to add the new class of expressivity to the set of classes of expressivity in operation 628. The operation returns. In some aspects, operations 622, 624, and 626 may occur in parallel with operations 628, 630, and 632, i.e., these two sets of operations need not occur in the depicted order and may be performed independently of each other.

FIG. 6C presents a flowchart 640 illustrating a method for analyzing a gap between an input language and a target output language, in accordance with an aspect of the present application. The operations described below in flowchart 640 relating to analyzing the gap between an input language and a target output language may be performed by, e.g., a combination of multi-class expressivity analysis module 104 of FIG. 1 (further described in relation to FIGS. 2A, 2B, 2C, and 6A) and functionality compensation module 106 of FIG. 1 (further described in relation to FIGS. 2C, 4, and 6C). The system determines a first set of optimal workflow features for the input language and a second set of optimal workflow features for the target output language (operation 642). Determining optimal workflow features for a workflow language may include determining sets A, B, C, and D, to obtain an optimal set E. Set A may include the enumerable set of all workflow instances; set B may include all non-redundant workflow instances; set C may include correctly executable workflow instances; and set D may include productive workflow instances. The system may take the intersection of these four sets (A-D) to obtain the optimal set E, as described above in relation to FIGS. 2A and 3.

The system calculates first scores for each class of expressivity based on the first set of optimal workflow features for the input language (operation 644), and the system calculates second scores for each class of expressivity based on the second set of optimal workflow features for the target output language (operation 646). For example, if syntactic expressivity (described as class c¹ (262) in relation to FIG. 2B) has been validated as an expressivity class and is part of, e.g., workflow language module 130 of FIG. 1, the system may calculate the syntactic expressivity score for each of the input language and the target output language, similar to the calculation depicted in FIG. 3. The system may also calculate the expressivity score for other expressivity classes for each of the input language and the target output language, such as the three expressivity classes listed as part of the set of expressivity classes 134 in workflow language module 130 of FIG. 1 or the six expressivity classes c¹-c⁶ described above in relation to FIG. 2B.

The system aggregates the first scores (operation 648) and aggregates the second scores (operation 650). For example, the system may sum all the first scores and all the second scores. In some aspects, the system may aggregate the first and second scores based on a weight, or a ranking assigned to or associated with each expressivity class, where some expressivity classes may be assigned a higher weight and other expressivity classes may be assigned a lower weight. A user may configure these weights upon adding an expressivity class, at startup, or during an attempt to obtain a target output language based on an input language. Alternatively, the system may configure the weights upon adding or validating the expressivity classes, e.g., as a default or other value. The weights may also be assigned or changed dynamically based on policies or rules associated with any component or module of the system.

The system calculates a difference between the aggregated first scores and the aggregated second scores (operation 652), e.g., based on subtracting one value from another. If the difference is not greater than a first predetermined threshold (decision 654), the system determines that the target output language is a match for the input language (operation 656). The predetermined threshold may be set or configured by the system or a user of the system. The predetermined threshold may also be based on an analysis of historical data stored in relation to scores calculated based on optimal workflow features for a respective workflow language or a respective pair of workflow languages. A lower predetermined threshold may result in a target output language with increased accuracy but decreased efficiency, while a higher predetermined threshold may result in a target output language with decreased accuracy but increased efficiency. The system may return and display information to the user regarding this determination, including information relating to calculations performed by the functionality compensation module (e.g., module 106 of FIG. 1). The displayed information may include a recommendation for the target output language or an alternative target output language and may further allow the user to accept or reject the recommendation.

If the difference is greater than the first predetermined threshold (decision 654), the system determines that the target output language is not a match for the input language (operation 658). The system may return and display information to the user regarding this determination, including information relating to calculations performed by the functionality compensation module (e.g., module 106 of FIG. 1). As described above in relation to FIG. 4 and operations 610, 612, and 614 of FIG. 6A, the system may display information which allows the user to accept or reject a first recommendation for a first target output language, including the gaps in expressivity or any functionally equivalent code which covers unique expressivities representing the gap between the input language and the target output language. The system may also display information which allows the user to accept or reject a second recommendation for one or more alternative target output languages, including why a given alternative target output language may be a better match for the input language than any other target output language. For example, the alternative target output language (from the second recommendation) may be better than the first target output language (from the first recommendation) because the alternative target output language may include the ability to more accurately express functionalities of the input language (including the unique expressivities 414 depicted above in relation to FIG. 4) than the first target output language. That is, the potential functionality loss between the input language and the alternative target output language may be less than the potential functionality loss between the input language and the first target output language.

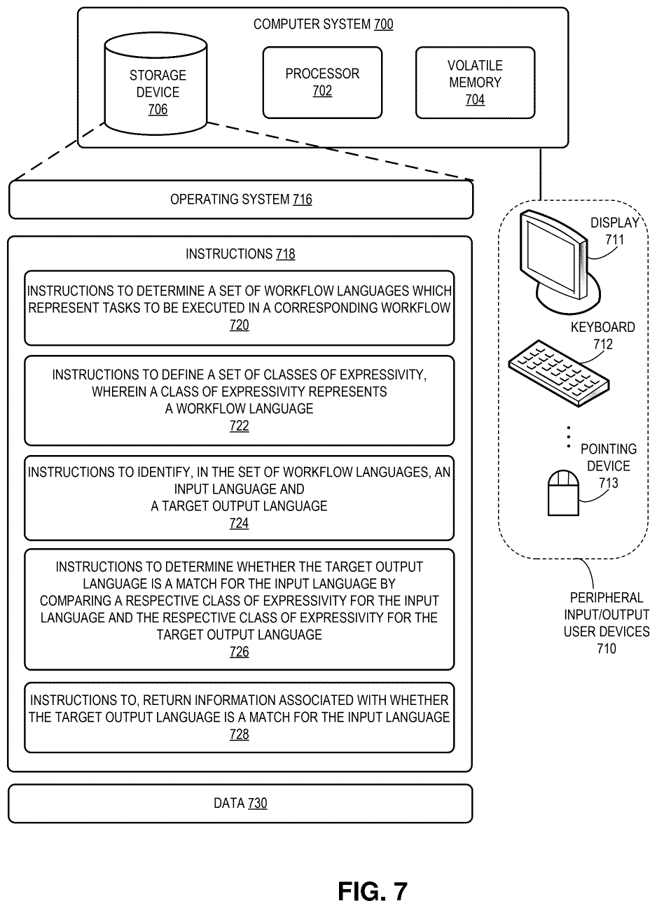

FIG. 7 illustrates a computer system 700 which facilitates an expressivity-aware transpiler for workflow languages, in accordance with an aspect of the present application. Computer system 700 includes a processor 702, a memory 704, and a storage device 706. Memory 704 may include a volatile memory (e.g., random access memory (RAM)) that serves as a managed memory and can be used to store one or more memory pools. Furthermore, computer system 700 may be coupled to peripheral I/O user devices 710 (e.g., a display device 711, a keyboard 712, and a pointing device 713). Storage device 706 includes non-transitory computer-readable storage medium and stores an operating system 716, instructions 718, and data 730. Computer system 700 may include fewer or more entities or instructions than those shown in FIG. 7.

Instructions 718 can include instructions, which when executed by computer system 700, can cause computer system 700 to perform methods and/or processes described in this disclosure. Specifically, instructions 718 may include instructions 720 to determine a set of workflow languages which represent tasks to be executed in a corresponding workflow, as described above in relation to transpiler 102, set of workflow languages 132, workflow language module 130 of FIG. 1, and operation 602 of FIG. 6A.

Instructions 718 may include instructions 722 to define a set of classes of expressivity, wherein a class of expressivity represents a workflow language, as described above in relation to transpiler 102, set of expressivity classes 134, workflow language module 130 of FIG. 1, and operation 604 of FIG. 6A.

Instructions 718 may include instructions 724 to identify, in the set of workflow languages, an input language and a target output language, as described above in relation to transpiler 102, workflow language A (110), IR-A (114), IR-B (124), and workflow language B (120), as well as the intermediate modules which transform a workflow language into its intermediate representation and back (e.g., workflow generator modules 116/126 and IR generator modules 112/122 of FIG. 1). Identifying the input language is also described above in relation to operation 606 of FIG. 6A.

Instructions 718 may include instructions 726 to determine whether the target output language is a match for the input language by comparing a respective class of expressivity for the input language and the respective class of expressivity for the target output language, as described above in relation to functionality compensation module 106 of FIG. 1, the operations of FIGS. 4 and 6C relating to analyzing the gap between two workflow languages, and operation 608 of FIG. 6A.

Instructions 718 may include instructions 728 to return information associated with whether the target output language is a match for the input language, as described above in relation to operation 610 of FIG. 6A.

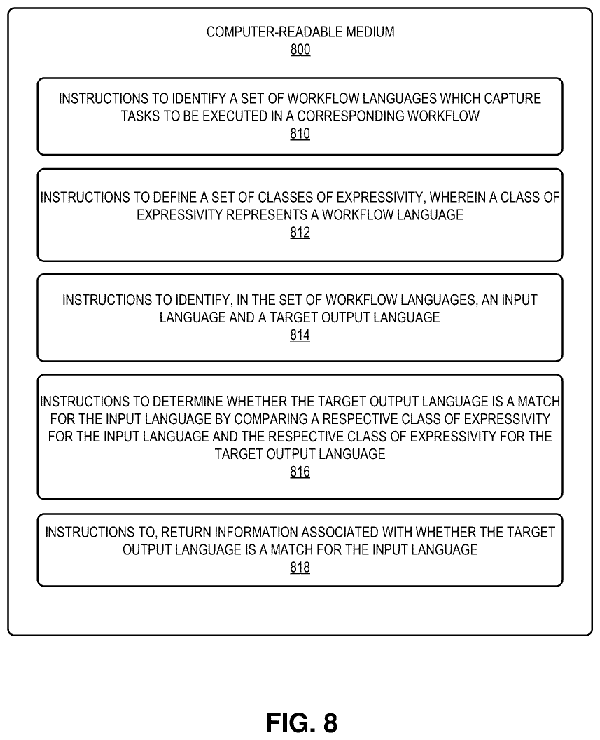

Instructions 718 may include more instructions than those shown in FIG. 7. For example, instructions 718 may include instructions for executing the operations described above in relation to: the environment of FIG. 1; the communications and operations of FIGS. 3-5; the operations depicted in the flowcharts of FIGS. 6A, 6B, and 6C; and the instructions of CRM 800 in FIG. 8.

Data 730 can include any data that is required as input or that is generated as output by the methods, operations, communications, and/or processes described in this disclosure. Specifically, data 730 can store at least: a workflow language; a class of expressivity; an input language; a target output language; a determination of whether a target output language is a match for an input language; an expressivity class score; aggregated expressivity class scores; a comparison of two scores; a set of optimal workflow features for a workflow language; a calculated score based on workflow features for a workflow language; a difference; a predetermined threshold; a weight or ranking; a set of workflow instances based on all enumerable workflows, non-redundant workflows, correctly executable workflows, or productive workflows; an indication that a first language matches or does not match a second workflow language; a recommendation; additional code; functionally equivalent code; a description; and a description of a gap between expressivity in the input language and expressivity in the target output language.

FIG. 8 illustrates a computer-readable medium (CRM) 800 which facilitates an expressivity-aware transpiler for workflow languages, in accordance with an aspect of the present application. CRM 800 can be a non-transitory computer-readable medium or device storing instructions that when executed by a computer or processor cause the computer or processor to perform a method. CRM 800 may store instructions 810 to identify a set of workflow languages which capture tasks to be executed in a corresponding workflow, as described above in relation to transpiler 102, set of workflow languages 132, workflow language module 130 of FIG. 1, and operation 602 of FIG. 6A.

CRM 800 may store instructions 812 to determine a set of classes of expressivity, wherein a class of expressivity represents a workflow language, as described above in relation to transpiler 102, set of expressivity classes 134, workflow language module 130 of FIG. 1, and operation 604 of FIG. 6A.

CRM 800 may store instructions 814 to identify, in the set of workflow languages, an input language and a target output language, as described above in relation to transpiler 102 and elements 110, 114, 120, and 124 of FIG. 1 as well as operation 606 of FIG. 6A.

CRM 800 may store instructions 816 to determine whether the target output language is a match for the input language by comparing a respective class of expressivity for the input language and the respective class of expressivity for the target output language, as described above in relation to functionality compensation module 106 of FIG. 1, the operations of FIGS. 4 and 6C relating to analyzing the gap between two workflow languages, and operation 608 of FIG. 6A.

CRM 800 may store instructions 818 to return information associated with whether the target output language is a match for the input language, as described above in relation to operation 610 of FIG. 6A.

CRM 800 may include more instructions than those shown in FIG. 8. For example, CRM 600 may also store instructions for executing the operations described above in relation to: the environment of FIG. 1; the communications and operations of FIGS. 3-5; the operations depicted in the flowcharts of FIGS. 6A, 6B, and 6C; and instructions 718 of computer system 700 in FIG. 7.

In general, the disclosed aspects provide a method, a computer system, and a computer-readable medium which facilitate an expressivity-aware transpiler for workflow languages. During operation, the system determines a set of workflow languages which capture tasks to be executed in a corresponding workflow. The system defines a set of classes of expressivity, wherein a class of expressivity represents a workflow language. The system identifies, in the set of workflow languages, an input language and a target output language. The system determines whether the target output language is a match for the input language by comparing a respective class of expressivity for the input language and the respective class of expressivity for the target output language. The system returns information associated with whether the target output language is a match for the input language.

In a variation on this aspect, determining whether the target output language is a match for the input language comprises analyzing a gap between the input language and the target output language. The system analyzes the gap by performing the following operations. The system: determines a first set of optimal workflow features for the input language and a second set of optimal workflow features for the target output language; calculates first scores for each class of expressivity based on the first set of optimal workflow features for the input language; calculates second scores for each class of expressivity based on the second set of optimal workflow features for the target output language; aggregates the first scores; aggregates the second scores; and calculates a difference between the aggregated first scores and the aggregated second scores.

In a variation on this aspect, the system determines that the target output language is a match for the input language in response to the difference being greater than a first predetermined threshold. The system determines that the target output language is not a match for the input language in response to the difference being less than or equal to the first predetermined threshold.

In a further variation, a respective set of optimal workflow features for a respective language is based on an intersection of: an enumerable set of all workflow instances associated with the respective language; a set of non-redundant workflow instances associated with the respective language; a set of correctly executable workflow instances associated with the respective language; and a set of productive workflow instances associated with the respective language.

In a further variation, the returned information comprises at least one of: an indication that the target output language matches the input language; an indication that the target output language does not match the input language; a recommendation for a first alternative target output language that better matches the input language; a recommendation for a second alternative target output language comprising the target output language and additional code rendering the target output language functionally equivalent to the input language; a description of the first set of optimal workflow features, the second set of optimal workflow features, the calculated first scores, the calculated second scores, the aggregated first scores, the aggregated second scores, or the calculated difference; or a description of a gap between expressivity in the input language and expressivity in the target output language.

In a further variation, subsequent to returning the information, the system displays the information on a display device associated with a user. The user identifies the input language. The information further includes interactive elements allowing the user to: accept or reject a first recommendation included in the displayed information, wherein the first recommendation indicates that the target output language is a match for the input language; and accept or reject a second recommendation included in the displayed information, wherein the second recommendation indicates that the target output language is not a match for the input language and further recommends the first alternative target output language or the second alternative target output language.

In a further variation, a respective class of expressivity is based on at least one of: syntax including an arrangement of symbols based on rules and relationships between the symbols; semantics including a meaning associated with the symbols; conceptual elements, dependencies of the conceptual elements, and relationships between the conceptual elements; absolute linguistics as a distance-based measure between languages; dynamic or runtime measures derived from a variability in an increase or decrease in a number of execution paths associated with a language; or graphs including measures of mathematical expressivity resulting in quantifiable differences between languages.

In a further variation, the system receives a request to add a new workflow language to the set of workflow languages. The system validates the new workflow language based on whether a set of optimal workflow features for the new workflow language can be determined. The system adds the new workflow language to the set of workflow languages in response to successfully validating the new workflow language.

In a further variation, the system receives a request to add a new class of expressivity to the set of classes of expressivity. The system validates the new class of expressivity based on parameters of the new class of expressivity matching parameters of a benchmark class of expressivity. The system adds the new class of expressivity to the set of classes of expressivity in response to successfully validating the new class of expressivity.

In a further variation, the input language comprises an intermediate representation of the input language. The target output language comprises an intermediate representation of the target output language. The intermediate representation of the input language and the intermediate representation of the target output language are generated based on a language-independent specification.

In another aspect, a computer system comprises a processor and a storage device storing instructions which when executed by the processor comprise instructions to determine a set of workflow languages which represent tasks to be executed in a corresponding workflow. The instructions are further to define a set of classes of expressivity, wherein a class of expressivity represents a workflow language. The instructions are further to identify, in the set of workflow languages, an input language and a target output language. The instructions are further to determine whether the target output language is a match for the input language by comparing a respective class of expressivity for the input language and the respective class of expressivity for the target output language. The instructions are further to return information associated with whether the target output language is a match for the input language. The computer system may include a content-processing system which includes the above-described instructions and instructions to perform the operations described herein, including in relation to: the environment of FIG. 1; the communications and operations of FIGS. 3-5; the operations depicted in the flowcharts of FIGS. 6A, 6B, and 6C; instructions 718 of computer system 700 in FIG. 7; and the instructions of CRM 800 in FIG. 8.

In another aspect, a non-transitory computer-readable storage medium (or CRM) stores instructions to identify a set of workflow languages which capture tasks to be executed in a corresponding workflow. The instructions are further to determine a set of classes of expressivity, wherein a class of expressivity represents a workflow language. The instructions are further to identify, in the set of workflow languages, an input language and a target output language. The instructions are further to determine whether the target output language is a match for the input language by comparing a respective class of expressivity for the input language and the respective class of expressivity for the target output language. The instructions are further to return information associated with whether the target output language is a match for the input language. The CRM can also store instructions for executing the operations described above in relation to: the environment of FIG. 1; the communications and operations of FIGS. 3-5; the operations depicted in the flowcharts of FIGS. 6A, 6B, and 6C; instructions 718 of computer system 700 in FIG. 7; and the instructions of CRM 800 in FIG. 8.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A method, comprising:
determining a set of workflow languages which capture tasks to be executed in a corresponding workflow;
defining a set of classes of expressivity, wherein a class of expressivity represents a workflow language;
identifying, in the set of workflow languages, an input language and a target output language;
determining whether the target output language is a match for the input language by comparing a respective class of expressivity for the input language and the respective class of expressivity for the target output language; and
returning information associated with whether the target output language is a match for the input language.

2. The method of claim 1, wherein determining whether the target output language is a match for the input language comprises analyzing a gap between the input language and the target output language by:
determining a first set of optimal workflow features for the input language and a second set of optimal workflow features for the target output language;
calculating first scores for each class of expressivity based on the first set of optimal workflow features for the input language;
calculating second scores for each class of expressivity based on the second set of optimal workflow features for the target output language;
aggregating the first scores;
aggregating the second scores; and
calculating a difference between the aggregated first scores and the aggregated second scores.

3. The method of claim 2, further comprising:
determining that the target output language is a match for the input language in response to the difference being greater than a first predetermined threshold; and
determining that the target output language is not a match for the input language in response to the difference being less than or equal to the first predetermined threshold.

4. The method of claim 2, wherein a respective set of optimal workflow features for a respective language is based on an intersection of:
an enumerable set of all workflow instances associated with the respective language;
a set of non-redundant workflow instances associated with the respective language;
a set of correctly executable workflow instances associated with the respective language; and
a set of productive workflow instances associated with the respective language.

5. The method of claim 2, wherein the returned information comprises at least one of:
an indication that the target output language matches the input language;
an indication that the target output language does not match the input language;
a recommendation for a first alternative target output language that better matches the input language;
a recommendation for a second alternative target output language comprising the target output language and additional code rendering the target output language functionally equivalent to the input language;
a description of the first set of optimal workflow features, the second set of optimal workflow features, the calculated first scores, the calculated second scores, the aggregated first scores, the aggregated second scores, or the calculated difference; or
a description of a gap between expressivity in the input language and expressivity in the target output language.

6. The method of claim 5, further comprising:
subsequent to returning the information, displaying the information on a display device associated with a user;
wherein the user identifies the input language; and
wherein the information further includes interactive elements allowing the user to:
accept or reject a first recommendation included in the displayed information, wherein the first recommendation indicates that the target output language is a match for the input language; and
accept or reject a second recommendation included in the displayed information, wherein the second recommendation indicates that the target output language is not a match for the input language and further recommends the first alternative target output language or the second alternative target output language.

7. The method of claim 1, wherein a respective class of expressivity is based on at least one of:
syntax including an arrangement of symbols based on rules and relationships between the symbols;
semantics including a meaning associated with the symbols;
conceptual elements, dependencies of the conceptual elements, and relationships between the conceptual elements;
absolute linguistics as a distance-based measure between languages;
dynamic or runtime measures derived from a variability in an increase or decrease in a number of execution paths associated with a language; or
graphs including measures of mathematical expressivity resulting in quantifiable differences between languages.

8. The method of claim 1, further comprising:
receiving a request to add a new workflow language to the set of workflow languages;
validating the new workflow language based on whether a set of optimal workflow features for the new workflow language can be determined; and
adding the new workflow language to the set of workflow languages in response to successfully validating the new workflow language.

9. The method of claim 1, further comprising:
receiving a request to add a new class of expressivity to the set of classes of expressivity;
validating the new class of expressivity based on parameters of the new class of expressivity matching parameters of a benchmark class of expressivity; and
adding the new class of expressivity to the set of classes of expressivity in response to successfully validating the new class of expressivity.

10. The method of claim 1,
wherein the input language comprises an intermediate representation of the input language;
wherein the target output language comprises an intermediate representation of the target output language; and
wherein the intermediate representation of the input language and the intermediate representation of the target output language are generated based on a language-independent specification.

11. A computer system, comprising:
a processor; and
a storage device storing instructions which when executed by the processor comprise instructions to:
determine a set of workflow languages which represent tasks to be executed in a corresponding workflow;
define a set of classes of expressivity, wherein a class of expressivity represents a workflow language;
identify, in the set of workflow languages, an input language and a target output language;
determine whether the target output language is a match for the input language by comparing a respective class of expressivity for the input language and the respective class of expressivity for the target output language; and
return information associated with whether the target output language is a match for the input language.

12. The computer system of claim 11, wherein the instructions to determine whether the target output language is a match for the input language further comprise instructions to:
analyze a gap between the input language and the target output language;
determine a first set of optimal workflow features for the input language and a second set of optimal workflow features for the target output language;
calculate first scores for each class of expressivity based on the first set of optimal workflow features for the input language;
calculate second scores for each class of expressivity based on the second set of optimal workflow features for the target output language;
aggregate the first scores;
aggregate the second scores; and
generate a difference between the aggregated first scores and the aggregated second scores.

13. The computer system of claim 12, wherein the instructions are further to:
determine whether the target output language is a match for the IP in response to a comparison of the generated difference with a first predetermined threshold.

14. The computer system of claim 12, wherein a respective set of optimal workflow features for a respective language is based on features of an optimal set of enumerable code variants which correctly execute a minimal set of productive workflows.

15. The computer system of claim 11, wherein the returned information comprises at least one of:
an indication that the target output language matches the input language;
an indication that the target output language does not match the input language;
a recommendation for a first alternative target output language that better matches the input language;
a recommendation for a second alternative target output language comprising the target output language and additional code rendering the target output language functionally equivalent to the input language;
a description of the first set of optimal workflow features, the second set of optimal workflow features, the calculated first scores, the calculated second scores, the aggregated first scores, the aggregated second scores, or the calculated difference; or
a description of a gap between expressivity in the input language and expressivity in the target output language.

16. The computer system of claim 15, wherein the instructions are further to:
subsequent to returning the information, display the information on a display device associated with a user;
wherein the input language is identified by the user; and
wherein the information further includes interactive elements allowing the user to:
accept or reject a first recommendation included in the displayed information, wherein the first recommendation indicates that the target output language is a match for the input language; and
accept or reject a second recommendation included in the displayed information, wherein the second recommendation indicates that the target output language is not a match for the input language and further indicates the first alternative target output language or the second alternative target output language.

17. The computer system of claim 11, wherein a respective class of expressivity is based on at least one of:
syntax including an arrangement of symbols based on rules and relationships between the symbols;
semantics including a meaning associated with the symbols;
conceptual elements, dependencies of the conceptual elements, and relationships between the conceptual elements;
absolute linguistics as a distance-based measure between languages;
dynamic or runtime measures derived from a variability in an increase or decrease in a number of execution paths associated with a language; or
graphs including measures of mathematical expressivity resulting in quantifiable differences between languages.

18. The computer system of claim 11, wherein the instructions are further to:
receive a request to add a new workflow language to the set of workflow languages;
validate the new workflow language based on whether a set of optimal workflow features for the new workflow language can be determined;
add the new workflow language to the set of workflow languages in response to successfully validating the new workflow language;
receive a request to add a new class of expressivity to the set of classes of expressivity;
validate the new class of expressivity based on parameters of the new class of expressivity matching parameters of a benchmark class of expressivity; and
add the new class of expressivity to the set of classes of expressivity in response to successfully validating the new class of expressivity.

19. The computer system of claim 11,
wherein the input language comprises an intermediate representation of the input language;
wherein the target output language comprises an intermediate representation of the target output language; and
wherein the intermediate representation of the input language and the intermediate representation of the target output language are generated based on a language-independent specification.

20. A non-transitory computer-readable medium storing instructions to:
identify a set of workflow languages which capture tasks to be executed in a corresponding workflow;
determine a set of classes of expressivity, wherein a class of expressivity represents a workflow language;
identify, in the set of workflow languages, an input language and a target output language;
determine whether the target output language is a match for the input language by comparing a respective class of expressivity for the input language and the respective class of expressivity for the target output language; and
return information associated with whether the target output language is a match for the input language.
